(19) United States
(12) Patent Application Publication
(10) Pub. No.: US 2026/0022259 A1
(43) Pub. Date: Jan. 22, 2026

(54) METHOD FOR MANUFACTURING ELECTROMAGNETIC DEVICE

(71) Applicant: National Tsing Hua University, Hsinchu City (TW)

(72) Inventors: Shang-Hua Yang, Hsinchu City (TW); Seyed Mostafa Latifi, Hsinchu City (TW); Shao-Hsuan Wu, Hsinchu City (TW)

(73) Assignee: National Tsing Hua University, Hsinchu City (TW)

(21) Appl. No.: 18/906,151

(22) Filed: Oct. 3, 2024

(30) Foreign Application Priority Data
Jul. 19, 2024 (TW) 113127057

(51) Int. Cl. C09D 7/61; C09D 7/65; C09D 133/04; H01Q 15/02

(52) U.S. Cl. CPC C09D 7/61; C09D 7/65; C09D 133/04; H01Q 15/02

(57) ABSTRACT

The disclosure provides a method for manufacturing an electromagnetic device, which includes the following steps. A material for adjusting a refractive index and/or an absorption coefficient is added to a main material and mixed to form a composite material for the electromagnetic device, in which the refractive index and/or the absorption coefficient of the composite material are different from the refractive index and/or the absorption coefficient of the main material. The composite material is used to form an optical component for the electromagnetic device.

### CROSS-REFERENCE TO RELATED APPLICATION

This application claims the priority benefit of Taiwan application serial no. 113127057, filed on Jul. 19, 2024. The entirety of the above-mentioned patent application is hereby incorporated by reference herein and made a part of this specification.

### BACKGROUND

### Technical Field

The disclosure relates to a method for manufacturing an electromagnetic device, and particularly relates to a method for manufacturing an electromagnetic device used in a terahertz system.

### Description of Related Art

Terahertz has demonstrated a variety of unique applications, including high-speed communications, non-destructive imaging, chemical substance identification, material property measurement, and biomedical measurement. Among various technologies for generating terahertz, photoconductive terahertz components are widely used in terahertz systems due to their advantages of small size, room temperature operation, and high bandwidth.

When manufacturing electromagnetic devices (such as lenses) for terahertz systems, the number, arrangement, shape, thickness, etc. of the electromagnetic devices will be adjusted according to the inherent optical properties of the material (such as refractive index, absorption coefficient, etc.) so as to obtain the desired optical properties. However, using the above methods to adjust the optical properties is subject to many limitations and has many defects. As electronic devices continue to develop toward being lighter, thinner, shorter, smaller, etc., the limitations and/or the defects will be difficult to meet current or future demands for electronic devices.

### SUMMARY

The disclosure provides a method for manufacturing an electromagnetic device, in which a material for adjusting the refractive index and/or the absorption coefficient is added to a main material and mixed to form a composite material for the electromagnetic device. The refractive index and/or the absorption coefficient of the composite material are different from the refractive index and/or the absorption coefficient of the main material, so that the composite material with the adjusted refractive index and/or absorption coefficient may be directly used to form an optical component with the desired optical properties, thereby reducing the limitations caused by the inherent optical properties of the material on the manufacturing of the electromagnetic device, so as to have advantages of improving the performance of the optical system, reducing the complexity of the optical system, or making the optical system easier to manufacture or have a more flexible design, etc.

An embodiment of the disclosure provides a method for manufacturing an electromagnetic device, which includes: adding a material for adjusting a refractive index and/or an absorption coefficient to a main material and mixing to form a composite material for the electromagnetic device, in which the refractive index and/or the absorption coefficient of the composite material are different from the refractive index and/or the absorption coefficient of the main material; and using the composite material to form an optical component for the electromagnetic device.

In some embodiments, the main material includes an organic material, an inorganic material, or a combination thereof.

In some embodiments, the material for adjusting the refractive index or absorption coefficient includes an organic or an inorganic compound.

In some embodiments, the material for adjusting the refractive index or absorption coefficient includes a non-solid material or a material in powder shape with a particle size less than a wavelength of a radiation for the electromagnetic device.

In some embodiments, the material for adjusting the refractive index or absorption coefficient is included in an amount greater than 0 volume % to 50 volume % based on a total volume of the composite material.

In some embodiments, the main material includes a photocurable resin, and the material for adjusting the refractive index and/or absorption coefficient includes titanium dioxide (TiO₂).

In some embodiments, the composite material may form the optical component by a subtractive manufacturing, additive manufacturing, or shaping/molding method.

In some embodiments, manufacturing method may include a lithography-based additive manufacturing process or a subtractive process.

In some embodiments, the method for manufacturing the electromagnetic device further includes: adding a stabilizing material to the main material when the material for adjusting the refractive index or absorption coefficient is added to the main material and mixed, in which the stabilizing material includes polyurethane dimethacrylate (UEDMA).

Based on the above, in the above method for manufacturing the electromagnetic device, the material for adjusting the refractive index and/or the absorption coefficient is added to the main material and mixed to form the composite material for the electromagnetic device. The refractive index and/or the absorption coefficient of the composite material are different from the refractive index and/or the absorption coefficient of the main material, so that the composite material with the adjusted refractive index and/or absorption coefficient may be directly used to form the optical component with the desired optical properties, thereby reducing the limitations caused by the inherent optical properties of the material on the manufacturing of the electromagnetic device, so as to have advantages of improving the performance of the optical system, having more compact optical elements, having lower insertion losses, reducing the complexity of the optical system, or making the optical system easier to manufacture or have a more flexible design, etc.

### BRIEF DESCRIPTION OF THE DRAWINGS

FIG. 1 is a flowchart of a method for manufacturing an electromagnetic device according to an embodiment of the disclosure.

FIG. 2A is a relation view of frequency-domain the refractive index of a manufactures sample with a material for adjusting the refractive index and/or the absorption coefficient being present in different contents in a main material.

FIG. 2B is a relation view of the frequency-domain absorption coefficient of a manufactured sample with a material for adjusting the refractive index and/or the absorption coefficient being present in different contents in a main material.

### DESCRIPTION OF THE EMBODIMENTS

The disclosure is more fully described with reference to the drawings of the present embodiments. However, the disclosure may also be embodied in various forms and should not be limited to the embodiments described herein. Thicknesses of layer and region in the drawings are enlarged for clarity. The same or similar reference numerals denote the same or similar elements, and are not repeated in the following paragraphs.

It will be understood that when an element is referred to as being “on” or “connected” to another element, it may be directly on or connected to the other element or intervening elements may be present. If an element is referred to as being “directly on” or “directly connected” to another element, there are no intervening elements present. As used herein, “connection” may refer to both physical and/or electrical connections, and “electrical connection” or “coupling” may refer to the presence of other elements between two elements.

As used herein, “about”, “approximately”, or “substantially” includes the stated value and the average value within an acceptable deviation of the particular value as determined by one of ordinary skill in the art, taking into account the measurement in question and the specific amount of measurement-related error (i.e., the limitations of the measurement system). For example, “about” may mean within one or a plurality of standard deviations of the stated value, or within +30%, +20%, +10%, +5%. Furthermore, as used herein, “about”, “approximately”, or “substantially” may encompass an acceptable range of deviation or standard deviation depending on optical properties, etching properties or other properties, and one standard deviation does not apply to all properties.

The terms used herein are used to merely describe exemplary embodiments and are not used to limit the present disclosure. In this case, unless indicated in the context specifically, otherwise the singular forms include the plural forms.

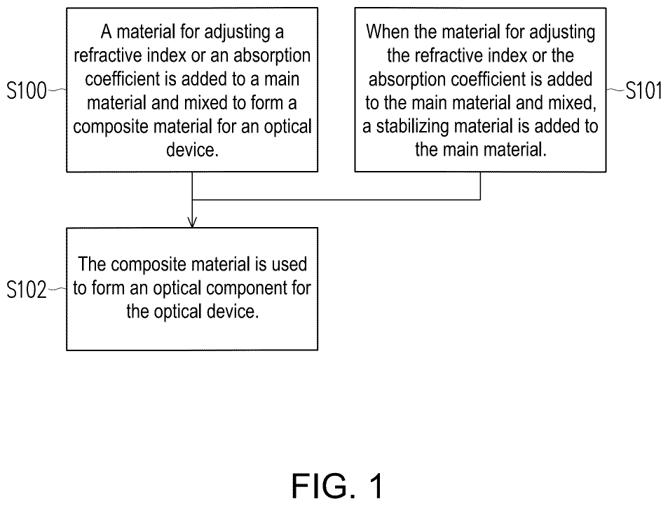

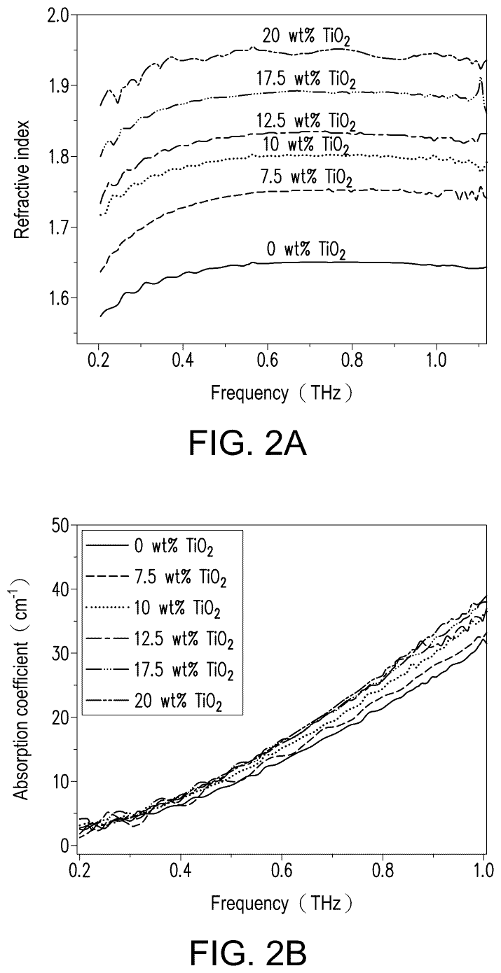

FIG. 1 is a flowchart of a method for manufacturing an electromagnetic device according to an embodiment of the disclosure. FIG. 2A is a relation view of the frequency-domain refractive index of a manufactured sample with a material for adjusting the refractive index and/or the absorption coefficient being present in different contents in a main material. FIG. 2B is a relation view of the frequency-domain absorption coefficient of a manufactured sample with a material for adjusting the refractive index and/or the absorption coefficient being present in different contents in a main material.

In the embodiment, the method for manufacturing the electromagnetic device may include the following steps.

First, referring to step S100 of FIG. 1, a material for adjusting a refractive index and/or an absorption coefficient is added to a main material and mixed to form a composite material for the electromagnetic device, in which the refractive index and/or the absorption coefficient of the composite material are different from the refractive index and/or the absorption coefficient of the main material. Next, referring to step S102, the composite material is used to form an optical component for the electromagnetic device. The refractive index and/or the absorption coefficient of the composite material are different from the refractive index and/or the absorption coefficient of the main material, so that the composite material with the adjusted refractive index and/or absorption coefficient may be directly used to form the optical component with the desired optical properties, thereby reducing the limitations caused by the inherent optical properties of the material on the manufacturing of the electromagnetic device, so as to have advantages of improving the performance of the optical system, having more compact components, having lower insertion loss, reducing the complexity of the optical system, or making the optical system easier to manufacture or have a more flexible design, etc.

In other words, before forming the optical component, the optical properties of the main material have been adjusted to the desired optical properties by adding the material for adjusting the refractive index and/or the absorption coefficient, so the method of using the composite material with the adjusted refractive index and/or absorption coefficient to form the optical component will not be limited by the inherent optical properties of the main material. Therefore, there is no need for some additional design (shape, thickness) or configuration (number, arrangement) to obtain the desired optical properties. In this way, the electromagnetic device will not suffer from defects such as bulkiness, high insertion loss, poor performance, deformation, complex design, etc. in order to obtain the desired optical properties, and may also be used with a variety of manufacturing methods or integrated into the design of a variety of optical systems.

In some embodiments, the main material may include an organic material, an inorganic material, or a combination thereof. In some embodiments, the main material may include a photocurable resin. In some embodiments, the main material may include acrylate compounds.

In some embodiments, the material for adjusting the refractive index or absorption coefficient may include an organic or an inorganic compound. In some embodiments, the material for adjusting the refractive index or absorption coefficient may include titanium dioxide (TiO₂).

In some embodiments, the material for adjusting the refractive index or absorption coefficient includes a material in powder shape with a particle size less than a wavelength of a radiation for the electromagnetic device. In some embodiments, the material for adjusting the optical properties may include a material with a particle size less than 1/10 of a wavelength of a radiation for the terahertz component, such that Rayleigh scattering becomes negligible. For example, at 1 THz (wavelength 300 microns), a particle size for the material for adjusting the refractive index or absorption coefficient should be less than 30 microns.

In some embodiments, the material for adjusting the refractive index or absorption coefficient is included in an amount greater than 0 volume % to 50 volume % based on a total volume of the composite material.

In some embodiments, the composite material may form the optical component for the electromagnetic device by a manufacturing method including 3D printing method. In some embodiments, the manufacturing method may include an additive process, a subtractive process, or a shaping process. The additive process may include extrusion-based processes (e.g., FDM, DIW, etc.), lithography-based processes (e.g., SLA, MSLA, DLP, etc.), powder bed fusion methods (e.g., SLS, SLM, etc.), or other additive processes such as a process of material jetting, a process of binder jetting, etc. The subtractive process may include a process of CNC cutting, machining methods (e.g., Lathe machining, turning, milling, etc.), or other subtractive processes using cutting equipment such as laser cut, water cut, wire cut, etc. The shaping process may include an injection molding method, a preform method, a casting method, or other material shaping methods (e.g., a drawing method, etc.).

In some embodiments, as shown in step S101 in FIG. 1, when the material for adjusting the refractive index or absorption coefficient is added to the main material and mixed, a stabilizing material is added to the main material, such that the deposition of metal oxides over time may be prevented by forming hydrogen bonds. In some embodiments, the stabilizing material may include polyurethane dimethacrylate (UEDMA).

Features of the disclosure will be described in more detail below with reference to Examples 1-5 and Comparative Example 1. Although the following embodiments are described, the materials used, the amounts and ratios thereof, the processing details, the processing flow, etc. may be appropriately changed without exceeding the scope of the disclosure. Therefore, the disclosure should not be limitedly interpreted by the embodiments described below.

### Examples 1-5

Titanium dioxide (TiO₂) was used as the material for adjusting the refractive index and/or the absorption coefficient, and based on having good wettability of titanium dioxide (TiO₂) in acrylate-based photocurable resin (Frontier, Taiwan) was used as the main material, so that rapid sedimentation may be prevented and a suitable medium may be provided for the dispersion of the TiO₂ agglomerates. TiO₂ (Sigma-Aldrich, USA) with a particle size of 25 nm to 35 nm was gradually added to the main material at the content shown in Table 1 below, and then, mixed for 10 minutes using a vibrating mixer and placed in a low vacuum chamber for 30 minutes to degas. Next, after functionalizing the monomer with TiO₂, isopropyl alcohol was used for adjusting the viscosity of the material to meet the requirements of the 3D printer.

### Comparative Example 1

Comparative Example 1 was prepared in the same manner as Examples 1-5, except that no material for adjusting the refractive index and/or the absorption coefficient was added to the main material.

TABLE 1

| | | | | | | Comparative |
|---|---|---|---|---|---|---|
| | Example 1 | Example 2 | Example 3 | Example 4 | Example 5 | Example 1 |
| Content of a material | 7.5 | 10 | 12.5 | 17.5 | 20 | 0 |
| for adjusting a | | | | | | |
| refractive index | | | | | | |
| and/or an absorption | | | | | | |
| coefficient (wt %) | | | | | | |
| Content of a material | 2 | 2.71 | 3.46 | 5.08 | 5.89 | 0 |
| for adjusting a | | | | | | |
| refractive index | | | | | | |
| and/or an absorption | | | | | | |
| coefficient (vol %) | | | | | | |

### Experiment 1

The composite materials of Examples 1-5 and Comparative Example 1 were used to make rectangular samples of 15 mm×15 mm×2 mm using an MSLA 3D printer to study the refractive index and/or the absorption coefficient of Examples 1-5 and Comparative Example 1. In this experiment, the refractive index spectrum of the material was measured using a terahertz time-domain spectroscopy (THz-TDS) system (Menlo Systems, Germany). After using a fast Fourier transform function to map the time domain data to the frequency domain, a phase difference between the reference data and the sample data was used to calculate the refractive index and the absorption coefficient of the sample. The experimental results are shown in FIG. 2A and FIG. 2B, in which Comparative Example 1 is marked as 0 wt % TiO₂, and Example 1 to 5 are respectively labeled as 7.5 wt % TiO₂, 10 wt % TiO₂, 12.5 wt % TiO₂, 17.5 wt % TiO₂, and 20 wt % TiO₂.

From the above Experiment 1, it can be confirmed that the composite material with the adjusted refractive index and/or absorption coefficient may be directly used to form the optical component with the desired optical properties, thereby reducing the limitations caused by the inherent optical properties of the material on the manufacturing of the electromagnetic device, so as to have advantages of improving the performance of the optical system, having more compact components, having lower insertion loss, reducing the complexity of the optical system, or making the optical system easier to manufacture or have a more flexible design, etc.

To sum up, in the above-mentioned method for manufacturing the electromagnetic device, the material for adjusting the refractive index and/or the absorption coefficient is added to the main material and mixed to form the composite material for the electromagnetic device. The refractive index and/or the absorption coefficient of the composite material are different from the refractive index and/or the absorption coefficient of the main material, so that the composite material with the adjusted refractive index and/or absorption coefficient may be directly used to form the optical component with the desired optical properties, thereby reducing the limitations caused by the inherent optical properties of the material on the manufacturing of the electromagnetic device, so as to have advantages of improving the performance of the optical system, having more compact components, having lower insertion loss, reducing the complexity of the optical system, or making the optical system easier to manufacture or have a more flexible design, etc.

What is claimed is:

1. A method for manufacturing an electromagnetic device, comprising:
adding a material for adjusting a refractive index and/or an absorption coefficient to a main material and mixing to form a composite material for the electromagnetic device, wherein the refractive index and/or the absorption coefficient of the composite material are different from the refractive index and/or the absorption coefficient of the main material; and
using the composite material to form an optical component for the electromagnetic device.

2. The method according to claim 1, wherein the main material comprises an organic material, an inorganic material, or a combination thereof.

3. The method according to claim 1, wherein the material for adjusting the refractive index and/or the absorption coefficient comprises an organic and/or inorganic compound.

4. The method according to claim 1, wherein the material for adjusting the refractive index and/or the absorption coefficient comprises a non-solid material or a material in powder shape with a particle size less than a wavelength of a radiation for the electromagnetic device.

5. The method according to claim 1, wherein the material for adjusting the refractive index and/or the absorption coefficient is included in an amount greater than 0 volume % to 50 volume % based on a total volume of the composite material.

6. The method according to claim 1, wherein the main material comprises a photocurable resin, and the material for adjusting the refractive index and/or the absorption coefficient comprises metals, nonmetals, or compounds with different refractive indices, including Zinc Oxide (ZnO), Zirconium Dioxide (ZrO₂ or Zirconia), Strontium Titanate (SrTiO₃), Aluminum Oxide (Al₂O₃ or Alumina), Gallium Arsenide (GaAs), Titanium Dioxide (TiO₂), Barium Strontium Titanate (BaSrTiO₃), and Magnesium Oxide (MgO).

7. The method according to claim 1, wherein the composite material forms the optical component for the electromagnetic device by a subtractive manufacturing, additive manufacturing, or forming/molding method.

8. The method according to claim 1, further comprising:
when the material for adjusting the refractive index and/or the absorption coefficient is added to the main material and mixed, adding a stabilizing material to the main material, wherein the stabilizing material comprises polyurethane dimethacrylate.
